(19) United States
(12) Patent Application Publication
(10) Pub. No.: US 2026/0078946 A1
(43) Pub. Date: Mar. 19, 2026

(54) COOLING TOWER, CARBON DIOXIDE CAPTURE DEVICE, AND METHOD FOR PROTECTING COOLING TOWER FILLER

(71) Applicant: MITSUBISHI HEAVY INDUSTRIES, LTD., Tokyo (JP)

(72) Inventors: Masaki Onishi, Tokyo (JP); Tetsu Ushiku, Tokyo (JP); Osamu Miyamoto, Tokyo (JP); Tatsuya Tsujiuchi, Tokyo (JP); Miku Iwamoto, Tokyo (JP); Kendall Fruchey, Humble, TX (US)

(73) Assignee: MITSUBISHI HEAVY INDUSTRIES, LTD., Tokyo (JP)

(21) Appl. No.: 18/885,978

(22) Filed: Sep. 16, 2024

(51) Int. Cl. F25J 3/02

(52) U.S. Cl. CPC F25J 3/0266

(57) ABSTRACT

A cooling tower that cools exhaust gas includes: a resin-made cooling tower packing that cools the exhaust gas flowing from a lower part to an upper part inside the cooling tower in a vertical direction; a condensed water circulation section including a condensed water circulation flow passage through which condensed water stored in the lower part of the cooling tower is pumped up by a pump and circulated to the upper part of the cooling tower, and a heat exchanger that cools the condensed water flowing through the condensed water circulation flow passage; and a condensed water distribution section connected to the condensed water circulation flow passage at the upper part of the cooling tower and that supplies the condensed water from above the cooling tower packing to the cooling tower packing.

### BACKGROUND OF THE INVENTION

### Field of the Invention

The present disclosure relates to a cooling tower, a carbon dioxide capture device, and a method for protecting a cooling tower packing.

### Description of Related Art

A carbon dioxide capture device that removes and captures carbon dioxide from exhaust gas includes a cooling tower that cools the exhaust gas, an absorption tower that absorbs the carbon dioxide contained in the cooled exhaust gas into an absorbing liquid to capture the carbon dioxide, and a regeneration tower that separates and regenerates the carbon dioxide from the absorbing liquid that has absorbed the carbon dioxide. The absorption tower includes a gas-liquid contact plate and a nozzle for spraying the absorbing liquid onto the gas-liquid contact plate, which are provided inside. The cooling tower includes a gas-liquid contact plate and a nozzle for spraying cooling water onto the gas-liquid contact plate, which are provided inside. Generally, the gas-liquid contact plate (packing) is formed of a metal material. However, since the metal-made gas-liquid contact plate is heavy, a structure supporting the gas-liquid contact plate needs to be increased in size. Therefore, for example, Patent Document 1 and Patent Document 2 describe technologies of using a resin material that is lighter than a metal material for the gas-liquid contact plate.

### PATENT DOCUMENTS

[Patent Document 1] Japanese Patent No. 5794775
[Patent Document 2] U.S. Pat. No. 4,950,430

### SUMMARY OF THE INVENTION

However, a resin-made gas-liquid contact plate (packing) has lower heat resistance and a greater linear expansion coefficient compared with a metal-made gas-liquid contact plate. Therefore, in the case where high-temperature exhaust gas is introduced or in the case where the temperature rises due to heat generated during the absorption of carbon dioxide by the absorbing liquid, deformation or damage may occur. In addition, melting or damage may occur in welding work such as maintenance.

The present disclosure provides a cooling tower, a carbon dioxide capture device, and a method for protecting a cooling tower packing that can prevent high-temperature exhaust gas exceeding a heat resistance temperature from flowing into a resin-made cooling tower packing.

According to an aspect of the present disclosure, a cooling tower that cools exhaust gas is provided, including: a resin-made cooling tower packing configured to cool the exhaust gas flowing from a lower part to an upper part inside the cooling tower in a vertical direction; a condensed water circulation section including a condensed water circulation flow passage through which condensed water stored in the lower part of the cooling tower is pumped up by a pump and circulated to the upper part of the cooling tower, and a heat exchanger configured to cool the condensed water flowing through the condensed water circulation flow passage; a condensed water distribution section connected to the condensed water circulation flow passage at the upper part of the cooling tower and configured to supply the condensed water from above the cooling tower packing to the cooling tower packing; and a cooling section including a cooling water distribution section configured to supply cooling water for cooling the exhaust gas to an upstream side of the cooling tower packing in a flow direction of the exhaust gas

According to another aspect of the present disclosure, a carbon dioxide capture device is provided, including: the cooling tower; an absorption tower configured to remove carbon dioxide contained in the exhaust gas cooled by the cooling tower by absorbing the carbon dioxide into an absorbing liquid; and a regeneration tower configured to regenerate the absorbing liquid by separating the carbon dioxide from the absorbing liquid discharged from the absorption tower.

According to still another aspect of the present disclosure, a method is provided for protecting a resin-made cooling tower packing that cools exhaust gas flowing inside a cooling tower, the method including: a step of circulating condensed water stored in a lower part of the cooling tower to an upper part of the cooling tower through a condensed water circulation flow passage by pumping up the condensed water with a pump and of cooling the condensed water flowing through the condensed water circulation flow passage with a heat exchanger; a step of supplying the condensed water from above the cooling tower packing to the cooling tower packing by a condensed water distribution section connected to the condensed water circulation flow passage at the upper part of the cooling tower; and a step of supplying cooling water for cooling the exhaust gas to an upstream side of the cooling tower packing in a flow direction of the exhaust gas with respect to by a cooling water distribution section.

According to the above-mentioned aspects, it is possible to prevent high-temperature exhaust gas exceeding the heat resistance temperature from flowing into the resin-made cooling tower packing.

### BRIEF DESCRIPTION OF THE DRAWINGS

FIG. 1 is a schematic diagram showing an overall configuration of a carbon dioxide capture system according to a first embodiment of the present disclosure.

FIG. 2 is a first schematic diagram showing a configuration example of a cooling tower according to the first embodiment of the present disclosure.

FIG. 3 is a second schematic diagram showing a configuration example of the cooling tower according to the first embodiment of the present disclosure.

FIG. 4 is a third schematic diagram showing a configuration example of the cooling tower according to the first embodiment of the present disclosure.

FIG. 5 is a fourth schematic diagram showing a configuration example of the cooling tower according to the first embodiment of the present disclosure.

FIG. 6 is a flowchart showing an example of processing of a cooling tower control unit according to the first embodiment of the present disclosure.

FIG. 7 is a first schematic diagram showing a configuration example of a carbon dioxide capture device according to a second embodiment of the present disclosure.

FIG. 8 is a second schematic diagram showing a configuration example of the carbon dioxide capture device according to the second embodiment of the present disclosure.

FIG. 9 is a schematic block diagram showing a configuration of a computer of a control unit according to at least one embodiment.

### DETAILED DESCRIPTION OF THE INVENTION

### First Embodiment

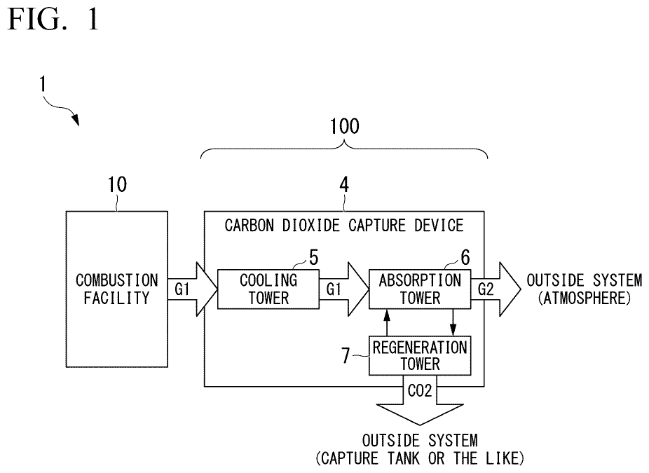

Hereinafter, a carbon dioxide capture system according to a first embodiment of the present disclosure will be described in detail with reference to FIGS. 1 to 6.

### (Overall Configuration of Carbon Dioxide Capture System)

FIG. 1 is a schematic diagram showing an overall configuration of the carbon dioxide capture system according to the first embodiment of the present disclosure. A carbon dioxide capture system 100 captures carbon dioxide from exhaust gas G1 discharged from a combustion facility 10 of a plant 1. The combustion facility 10 combusts fuel and air and discharges the exhaust gas G1. The combustion facility 10 may be, for example, any facility such as a boiler, an incinerator, or a gas turbine. The carbon dioxide capture system 100 includes a carbon dioxide capture device 4.

The carbon dioxide capture device 4 is provided downstream of the combustion facility 10. The carbon dioxide capture device 4 includes a cooling tower 5, an absorption tower 6, and a regeneration tower 7. The cooling tower 5 cools the exhaust gas G1. The absorption tower 6 removes carbon dioxide contained in the exhaust gas G1 cooled by the cooling tower 5 by absorbing the carbon dioxide into an absorbing liquid. The absorption tower 6 discharges purified gas G2, from which the carbon dioxide has been removed, to the outside of the system (atmosphere) and discharges the absorbing liquid that has absorbed the carbon dioxide to the regeneration tower 7. The regeneration tower 7 separates the carbon dioxide from the absorbing liquid discharged from the absorption tower 6 to regenerate the absorbing liquid. The regeneration tower 7 returns the regenerated absorbing liquid to the absorption tower 6 and discharges the separated carbon dioxide to the outside of the system. The carbon dioxide discharged from the regeneration tower 7 is stored in a capture tank or the like and used in another system or the like.

Although FIG. 1 shows an example in which the exhaust gas G1 discharged from the combustion facility 10 is directly introduced into the carbon dioxide capture device 4, the present disclosure is not limited to this device configuration. The carbon dioxide capture system 100 may be provided, as necessary, with a pretreatment facility for the exhaust gas G1, such as a dust collection device that removes soot and dust contained in the exhaust gas G1 or a desulfurization device that removes sulfur oxides (SOx) contained in the exhaust gas G1, between the combustion facility 10 and the carbon dioxide capture device 4.

### (Configuration Example 1 of Cooling Tower)

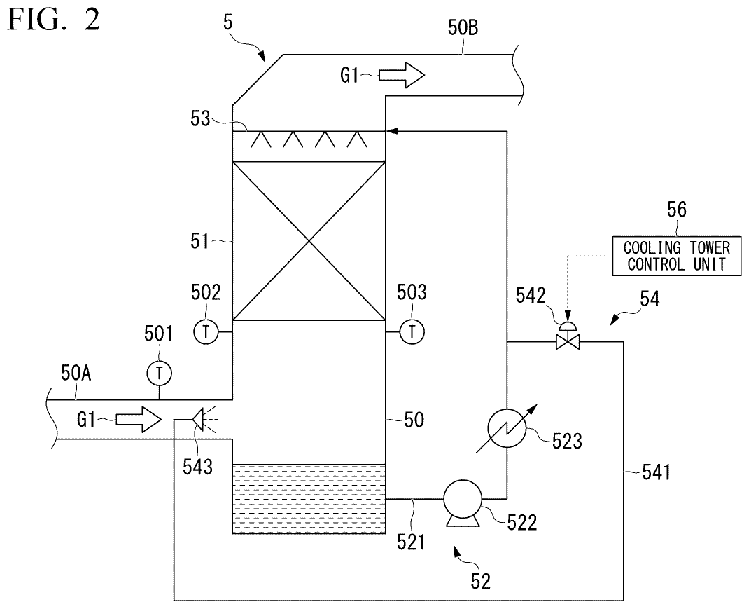

FIG. 2 is a schematic diagram showing a configuration example of the cooling tower according to the first embodiment of the present disclosure. As shown in FIG. 2, the cooling tower 5 includes a main body section 50, a cooling tower packing 51, a condensed water circulation section 52, a condensed water distribution section 53, a cooling section 54, and a cooling tower control unit 56.

The main body section 50 is a hollow container that extends in a vertical direction, and the exhaust gas G1 flows in the vertical direction through an inside of the main body section 50. An exhaust gas introduction flow passage 50A through which the exhaust gas G1 treated by a dust collection device 2 and a desulfurization device 3 is introduced into the inside of the main body section 50 is connected to a lower part of the main body section 50 (to an upstream side in a flow direction of the exhaust gas G1). An exhaust gas discharge flow passage 50B through which the exhaust gas G1 cooled inside the main body section 50 is discharged to the absorption tower 6 is connected to an upper part of the main body section 50 (to a downstream side in the flow direction of the exhaust gas G1). A blower (not shown) is provided between the cooling tower 5 and the absorption tower 6 (on a downstream side of the exhaust gas discharge flow passage 50B), and the exhaust gas is drawn into the absorption tower 6 by the blower. Condensed water generated by cooling moisture contained in the exhaust gas G1 is stored in the lower part of the main body section 50.

The cooling tower packing 51 is provided inside the main body section 50. The cooling tower packing 51 is formed of a resin material.

The condensed water circulation section 52 circulates the condensed water stored in the lower part of the main body section 50 to the upper part of the main body section 50 through a condensed water circulation flow passage 521 by pumping up the condensed water with a pump 522. The condensed water circulation flow passage 521 is provided with a heat exchanger 523 that cools the condensed water pumped up by the pump 522 to a predetermined temperature. A lower part of the condensed water circulation flow passage 521 is an upstream side in a flow direction of the condensed water, and an upper part thereof is a downstream side in the flow direction of the condensed water.

The condensed water distribution section 53 is connected to the condensed water circulation flow passage 521 at the upper part of the main body section 50. The condensed water distribution section 53 is disposed above the cooling tower packing 51 and supplies the condensed water cooled by the condensed water circulation section 52 to the cooling tower packing 51. The condensed water supplied from the condensed water distribution section 53 flows downward from above the cooling tower packing 51. The exhaust gas G1 flowing from the lower part to the upper part of the main body section 50 is cooled by coming into gas-liquid contact with the condensed water flowing through the cooling tower packing 51.

The cooling section 54 includes a cooling water distribution section 543 that supplies cooling water for cooling the exhaust gas G1 to an upstream side of the cooling tower packing 51 in the flow direction of the exhaust gas G1. In the example of FIG. 2, the cooling water distribution section 543 is provided inside the exhaust gas introduction flow passage 50A and supplies the cooling water into the exhaust gas introduction flow passage 50A.

With such a configuration, the cooling section 54 can lower the temperature of the exhaust gas G1 with the cooling water in the exhaust gas introduction flow passage 50A before the exhaust gas G1 flows into the main body section 50 of the cooling tower 5. Consequently, it is possible to prevent high-temperature exhaust gas G1 exceeding the heat resistance temperature from flowing into the resin-made cooling tower packing 51. As a result, the risk of deformation or damage to the cooling tower packing 51 can be reduced, thereby extending the lifespan of the cooling tower packing 51.

The cooling section 54 may supply the cooling water to the cooling water distribution section 543 by introducing the cooling water from outside the system. In addition, as in the example of FIG. 2, the cooling section 54 may use some of the condensed water circulating in the condensed water circulation section 52 as the cooling water. For example, as shown in FIG. 2, the cooling section 54 includes a cooling water flow passage 541 that branches from the condensed water circulation flow passage 521 at a downstream side of the heat exchanger 523 and through which some of the condensed water cooled by the heat exchanger 523 is introduced into the cooling water distribution section 543 as the cooling water. By reusing the condensed water in this way, the cooling section 54 does not need to introduce the cooling water from outside the system, and the operating cost of the cooling tower can be reduced. Additionally, since the condensed water that has been cooled by the heat exchanger 523 of the condensed water circulation section 52 is used as the cooling water, the temperature of the exhaust gas G1 can be effectively lowered.

The cooling section 54 may constantly supply the cooling water from the cooling water distribution section 543 during the operation of the cooling tower 5. In the case where a configuration is employed in which the cooling water is constantly supplied in this way, the cooling tower control unit 56, which will be described below, may be omitted. In addition, the cooling section 54 may supply the cooling water from the cooling water distribution section 543 in the case where the temperature of the exhaust gas G1 becomes high, in accordance with the control of the cooling tower control unit 56. For example, as shown in FIG. 2, the cooling water flow passage 541 is provided with a cooling water control valve 542. The cooling water control valve 542 opens and closes in accordance with the control of the cooling tower control unit 56 to start or stop supplying the cooling water. Further, the cooling water control valve 542 can increase or decrease a supply amount of the cooling water by changing an opening degree in accordance with the control of the cooling tower control unit 56.

In the case where the temperature of the exhaust gas G1 is equal to or higher than a limit temperature corresponding to the heat resistance temperature of the cooling tower packing 51, the cooling tower control unit 56 causes the cooling water distribution section 543 of the cooling section 54 to supply the cooling water. A detailed function (processing example) of the cooling tower control unit 56 will be described below.

Additionally, the main body section 50 is provided with at least one of a first temperature sensor 501 and second temperature sensors 502 and 503 that measure the temperature of the exhaust gas G1. Although FIG. 2 shows an example in which both the first temperature sensor 501 and the second temperature sensors 502 and 503 are provided, in any of other embodiments, at least only one of the first temperature sensor 501 and the second temperature sensors 502 and 503 need only be provided. In the case where the cooling tower control unit 56 is omitted as described above, neither the first temperature sensor 501 nor the second temperature sensors 502 and 503 need to be installed. The first temperature sensor 501 is provided near an outlet of the exhaust gas introduction flow passage 50A (near an inlet of the main body section 50) and measures the temperature of the exhaust gas G1 to be introduced into the main body section 50. The second temperature sensors 502 and 503 measure the temperature of the exhaust gas G1 to be introduced into the cooling tower packing 51 below the cooling tower packing 51 (on the upstream side in the flow direction of the exhaust gas G1). The second temperature sensors 502 and 503 are provided, for example, below the cooling tower packing 51 at at least two or more different positions in a horizontal direction, as shown in FIG. 2, in consideration of the possibility of temperature variations occurring in the cooling tower packing 51. It is possible to prevent the detection of the temperature rise of the exhaust gas G1 from being omitted even in the case where the temperature of the exhaust gas G1 varies depending on the position in the horizontal direction (temperature variations occur).

### (Configuration Example 2 of Cooling Tower)

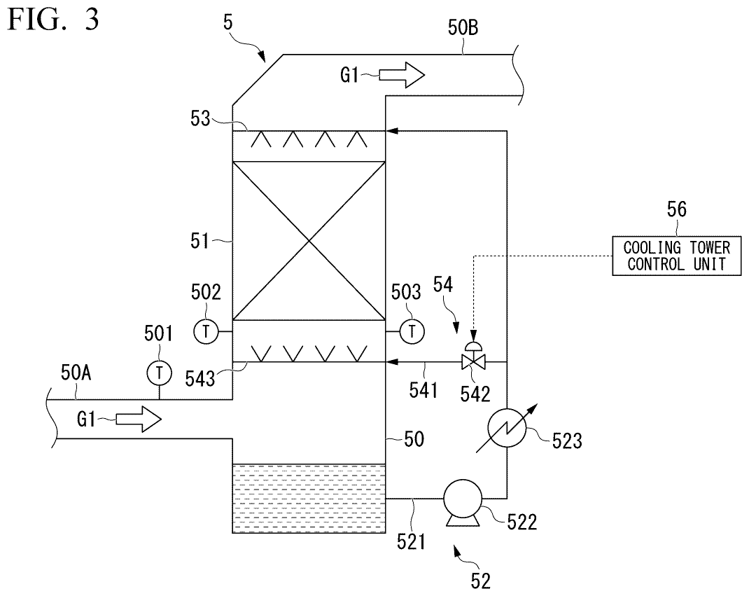

FIG. 3 is a second schematic diagram showing a configuration example of the cooling tower according to the first embodiment of the present disclosure. The cooling section 54 may be configured as shown in FIG. 3 instead of the configuration of FIG. 2. The configurations of the cooling water flow passage 541 and the cooling water control valve 542 are the same as those in FIG. 2.

In the example of FIG. 3, the cooling water distribution section 543 is provided below the cooling tower packing 51 inside the main body section 50. The cooling water distribution section 543 supplies the cooling water to the cooling tower packing 51 from below the cooling tower packing 51.

With such a configuration, the cooling section 54 can cool a lower side of the cooling tower packing 51 with the cooling water together with the exhaust gas G1 and can prevent the exhaust gas G1 and the cooling tower packing 51 from being high temperature exceeding the heat resistance temperature of the cooling tower packing 51. In addition, the temperature of the exhaust gas G1 is higher toward the lower part of the cooling tower packing 51 (toward the upstream side in the flow direction). Therefore, by supplying the cooling water toward a location where the temperature of the cooling tower packing 51 is likely to rise, the temperatures of the exhaust gas G1 and the cooling tower packing 51 can be appropriately lowered.

### (Configuration Example 3 of Cooling Tower)

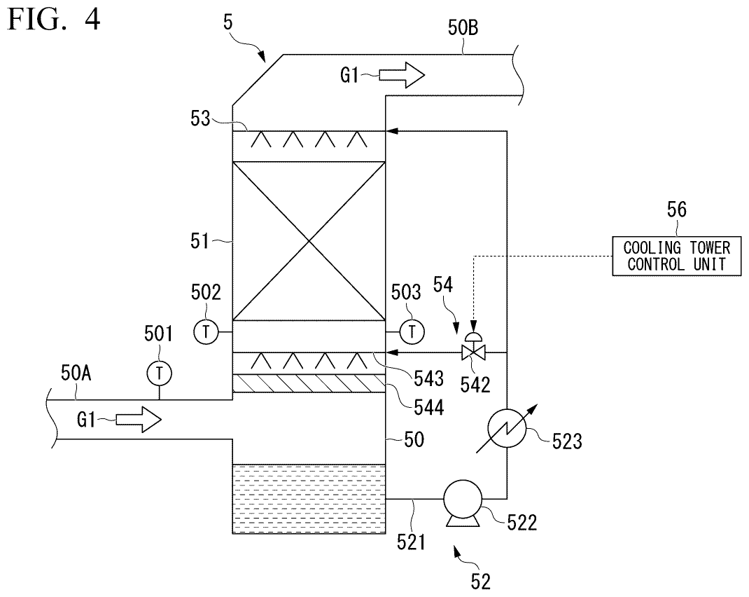

FIG. 4 is a third schematic diagram showing a configuration example of the cooling tower according to the first embodiment of the present disclosure. The cooling section 54 may be configured as shown in FIG. 4 instead of the configuration of FIG. 2 or 3. The configurations of the cooling water flow passage 541 and the cooling water control valve 542 are the same as those in FIG. 2.

In the example of FIG. 4, the cooling section 54 further includes a second cooling tower packing 544 disposed below the cooling tower packing 51 and spaced apart from the cooling tower packing 51 inside the main body section 50. The second cooling tower packing 544 has a heat resistance temperature higher than that of the cooling tower packing 51. Specifically, the second cooling tower packing 544 is a metal-made packing having a heat resistance temperature higher than that of the resin-made cooling tower packing 51.

Additionally, the cooling water distribution section 543 is provided between the cooling tower packing 51 and the second cooling tower packing 544 inside the main body section 50 and supplies the cooling water to the second cooling tower packing 544 from above.

With such a configuration, the cooling section 54 can lower the temperature of the exhaust gas G1 with the second cooling tower packing 544 having a higher heat resistance temperature before the exhaust gas G1 flows through the cooling tower packing 51. In addition, by cooling the second cooling tower packing 544 with the cooling water, the temperature of the exhaust gas G1 can be more reliably lowered before the exhaust gas G1 reaches the cooling tower packing 51.

### (Configuration Example 4 of Cooling Tower)

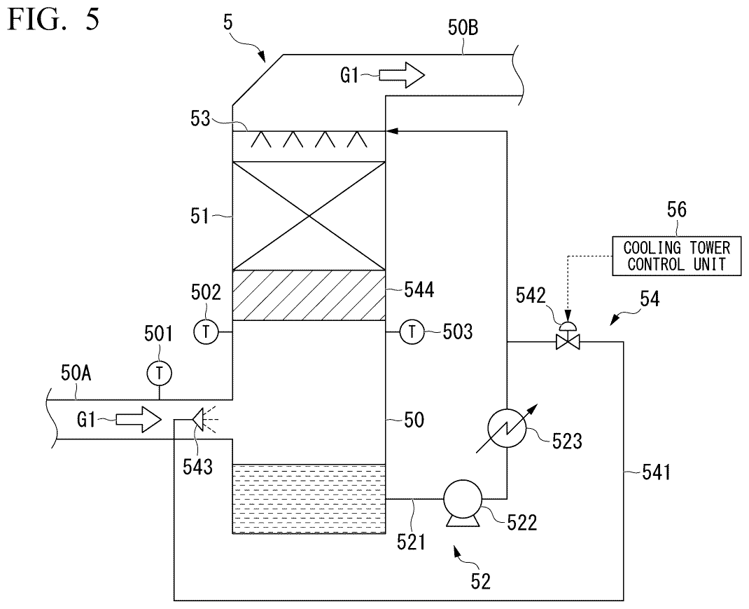

FIG. 5 is a fourth schematic diagram showing a configuration example of the cooling tower according to the first embodiment of the present disclosure. The cooling section 54 may be configured as shown in FIG. 5 instead of the configuration of FIG. 4.

In the example of FIG. 5, the second cooling tower packing 544 of the cooling section 54 is attached to a lower end of the cooling tower packing 51. The second cooling tower packing 544 is a metal-made packing having a heat resistance temperature higher than that of the cooling tower packing 51, in the same manner as in the example of FIG. 4.

Additionally, FIG. 5 shows an example in which the cooling water distribution section 543 is provided in the exhaust gas introduction flow passage 50A, in the same manner as in FIG. 2, but the present disclosure is not limited thereto. In another embodiment, the cooling water distribution section 543 may be configured to supply the cooling water to the second cooling tower packing 544 from below the cooling tower packing 51, that is, from below the second cooling tower packing 544, in the same manner as in FIG. 3. The configurations of the cooling water flow passage 541 and the cooling water control valve 542 are the same as those in FIG. 2.

In the same manner as in the example of FIG. 4, the cooling section 54 can lower the temperature of the exhaust gas G1 with the second cooling tower packing 544 having a higher heat resistance temperature before the exhaust gas G1 flows through the cooling tower packing 51. In addition, by cooling the second cooling tower packing 544 with the cooling water, the temperature of the exhaust gas G1 can be more effectively lowered.

In the examples of FIGS. 4 and 5, the second cooling tower packing 544 may have a vertical length shorter than that of the cooling tower packing 51. By doing so, the sum of the weights of the resin-made cooling tower packing 51 and the metal-made second cooling tower packing 544 can be reduced compared with the total weight in the case where the cooling tower packing 51 is made of metal, thereby preventing the structure that supports the packing from being increased in size.

### (Processing Example of Cooling Tower Control Unit)

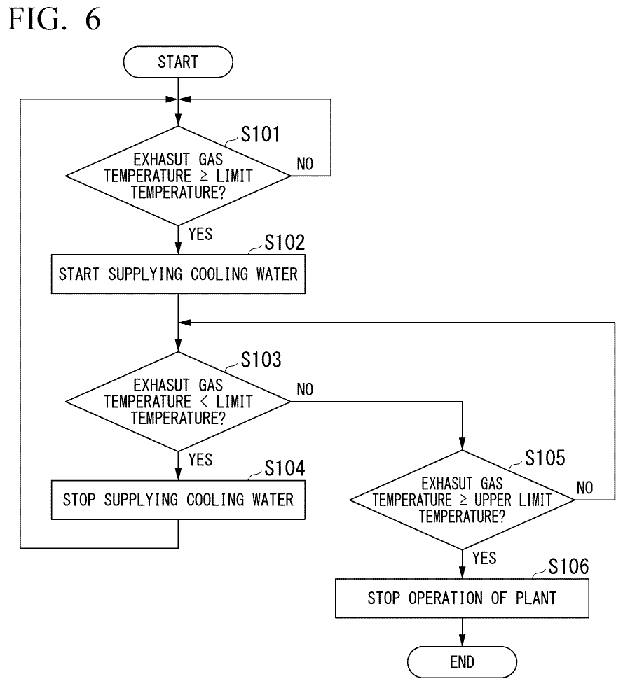

FIG. 6 is a flowchart showing an example of processing of the cooling tower control unit according to the first embodiment of the present disclosure. Here, an example will be described in which the cooling tower control unit 56 supplies the cooling water to the cooling section 54 only in the case where the temperature of the exhaust gas G1 increases.

The cooling tower control unit 56 acquires measured values of the first temperature sensor 501 and the second temperature sensors 502 and 503 for each predetermined processing cycle and monitors whether the temperature of the exhaust gas G1 is equal to or higher than the limit temperature corresponding to the heat resistance temperature of the cooling tower packing 51 (step S101). The limit temperature is set to be lower than the heat resistance temperature by, for example, a predetermined temperature. In the case where only one temperature sensor is provided (for example, in the case where only the first temperature sensor 501 is provided), the cooling tower control unit 56 monitors whether the measured value of the temperature sensor is equal to or higher than the limit temperature. In addition, in the case where a plurality of temperature sensors are provided (for example, in the case where the second temperature sensors 502 and 503 are provided, or in the case where both the first temperature sensor 501 and the second temperature sensors 502 and 503 are provided), the cooling tower control unit 56 monitors whether the measured value of any one temperature sensor is equal to or higher than the limit temperature. In the case where the second temperature sensors 502 and 503 are provided, measuring the temperature at a plurality of locations can prevent the detection of the temperature rise occurring only at a specific location from being omitted when the condensed water does not flow evenly in the cooling tower packing 51 and temperature distribution becomes uneven.

In the case where the temperature of the exhaust gas G1 is lower than the limit temperature (step S101; NO), the cooling tower control unit 56 waits until the next measured value is acquired.

On the other hand, in the case where the temperature of the exhaust gas G1 is equal to or higher than the limit temperature (step S101; YES), the cooling tower control unit 56 starts supplying the cooling water to the cooling section 54 (step S102). Specifically, the cooling tower control unit 56 opens the cooling water control valve 542 of the cooling section 54 so that some of the cooled condensed water flows from the condensed water circulation flow passage 521 to the cooling water flow passage 541. The cooling tower control unit 56 adjusts the opening degree of the cooling water control valve 542 such that, for example, the flow rate of the cooling water increases as the temperature of the exhaust gas G1 increases. Thus, the cooling water distribution section 543 supplies the cooling water to the exhaust gas introduction flow passage 50A (FIG. 2 or 5), to below the cooling tower packing 51 (FIG. 3), or to the second cooling tower packing 544 (FIG. 4) and lowers the temperature of the exhaust gas G1 before the exhaust gas G1 flows into the cooling tower packing 51.

Next, the cooling tower control unit 56 determines whether the temperature of the exhaust gas G1 is lower than the limit temperature (step S103). In the case where the temperature of the exhaust gas G1 is lower than the limit temperature (step S103; YES), the cooling tower control unit 56 closes the cooling water control valve 542 of the cooling section 54 to stop supplying the cooling water (step S104). After that, the processing in FIG. 6 is repeatedly executed for each processing cycle.

On the other hand, in the case where the temperature of the exhaust gas G1 is not lower than the limit temperature (step S103; NO), the cooling tower control unit 56 determines whether the temperature of the exhaust gas G1 has further risen to be equal to or higher than an upper limit temperature higher than the limit temperature (step S105). In the case where the temperature of the exhaust gas G1 is lower than the upper limit temperature higher than the limit temperature (step S105; NO), the cooling tower control unit 56 returns to step S103 and waits until the next measured value is acquired.

In the case where the temperature of the exhaust gas G1 has further risen to be equal to or higher than the upper limit temperature higher than the limit temperature (step S105; YES), the cooling tower control unit 56 stops the operation of the plant 1 and the supply of the exhaust gas G1 is cut off. The upper limit temperature may be set to, for example, any value between the heat resistance temperature of the cooling tower packing and the limit temperature. As a result, in the case where it is difficult to lower the temperature of the exhaust gas G1 only with the cooling water, it is possible to prevent the deformation or damage to the cooling tower packing 51 due to the high-temperature exhaust gas G1 exceeding the upper limit temperature.

Note that FIG. 6 is an example, and some of the processing may be added or changed in another embodiment. For example, the cooling tower control unit 56 executes the following processing instead of steps S105 and S106 or before steps S105 and S106. The cooling tower control unit 56 further sets a predetermined second limit temperature between the limit temperature and the upper limit temperature. In the case where the temperature of the exhaust gas G1 is not lower than the limit temperature (step S103; NO) and is equal to or higher than the second limit temperature, the flow rate of the exhaust gas G1 is reduced. Thereafter, in the case where the temperature of the exhaust gas G1 is lower than the second limit temperature, the flow rate of the exhaust gas G1 is restored, and in the case where the temperature of the exhaust gas G1 is lower than the limit temperature (step S103; YES), the supply of the cooling water is stopped (step S104). In the case where processing of reducing the flow rate of the exhaust gas G1 is added before steps S105 and S106, the operation of the plant 1 is stopped (step S106) when the temperature of the exhaust gas G1 is equal to or higher than the upper limit temperature (step S105; YES) even though the flow rate of the exhaust gas G1 is reduced. In this way, by reducing the flow rate of the exhaust gas G1 before stopping the operation of the plant 1, it is possible to prevent the deformation or damage to the cooling tower packing 51 while preventing a decrease in the operation rate of the plant 1.

In addition, in still another embodiment, in the case where the temperature of the exhaust gas G1 is equal to or higher than the limit temperature (step S101; YES), the operation of the plant 1 may be stopped. As a result, the deformation or damage to the cooling tower packing 51 can be more reliably prevented.

### (Action and Effect)

As described above, according to the present embodiment, the cooling tower 5 includes the resin-made cooling tower packing 51 that cools the exhaust gas G1 flowing inside the cooling tower 5 (main body section 50) from the lower part to the upper part in the vertical direction, the condensed water circulation section 52 including the condensed water circulation flow passage 521 through which the condensed water stored in the lower part of the cooling tower 5 is pumped up by a pump 522 and circulated to the upper part of the cooling tower 5, and the heat exchanger 523 that cools the condensed water flowing through the condensed water circulation flow passage 521, the condensed water distribution section 53 connected to the condensed water circulation flow passage 521 at the upper part of the cooling tower 5 and that supplies the condensed water from above the cooling tower packing 51 to the cooling tower packing 51, and the cooling section 54 including the cooling water distribution section 543 that supplies the cooling water for cooling the exhaust gas G1 to the upstream side of the cooling tower packing 51 in the flow direction of the exhaust gas G1.

The cooling tower 5 can prevent the high-temperature exhaust gas G1 exceeding the heat resistance temperature from flowing into the resin-made cooling tower packing 51. As a result, the risk of deformation or damage to the cooling tower packing 51 can be reduced, thereby extending the lifespan of the cooling tower packing 51.

The cooling water distribution section 543 of the cooling section 54 supplies the cooling water to the inside of the exhaust gas introduction flow passage 50A through which the exhaust gas G1 is introduced into the cooling tower 5.

The cooling tower 5 can lower the temperature of the exhaust gas G1 before the exhaust gas G1 flows into the cooling tower 5. Therefore, it is possible to prevent the high-temperature exhaust gas G1 exceeding the heat resistance temperature from flowing into the resin-made cooling tower packing 51.

In addition, the cooling water distribution section 543 of the cooling section 54 supplies the cooling water to the cooling tower packing 51 from below the cooling tower packing 51.

The cooling tower 5 can cool the lower side of the cooling tower packing 51 with the cooling water together with the exhaust gas G1, thereby preventing the exhaust gas G1 and the cooling tower packing 51 from being high temperature exceeding the heat resistance temperature of the cooling tower packing 51. Further, the temperature of the exhaust gas G1 is higher toward the lower part of the cooling tower packing 51 (toward the upstream side in the flow direction). Therefore, as the cooling tower 5 supplies the cooling water toward a location where the temperature of the cooling tower packing 51 is likely to rise, the temperatures of the exhaust gas G1 and the cooling tower packing 51 can be appropriately lowered.

Additionally, the cooling section 54 further includes the second cooling tower packing 544 disposed below the cooling tower packing 51 and that has a heat resistance temperature higher than that of the cooling tower packing 51.

The cooling tower 5 can lower the temperature of the exhaust gas G1 with the second cooling tower packing 544 having a higher heat resistance temperature before the exhaust gas G1 flows through the cooling tower packing 51. Therefore, it is possible to prevent the high-temperature exhaust gas G1 exceeding the heat resistance temperature from flowing into the resin-made cooling tower packing 51.

The second cooling tower packing 544 is disposed below the cooling tower packing 51 and spaced apart from the cooling tower packing 51, and the cooling water distribution section 543 is provided between the cooling tower packing 51 and the second cooling tower packing 544 and supplies the cooling water to the second cooling tower packing 544.

The cooling tower 5 can more reliably lower the temperature of the exhaust gas G1 before the exhaust gas G1 reaches the cooling tower packing 51 by using the second cooling tower packing 544 and the cooling water.

The cooling section 54 includes the cooling water flow passage 541 that branches from the condensed water circulation flow passage 521 at a downstream side of the heat exchanger 523 and through which some of the condensed water cooled by the heat exchanger 523 is introduced into the cooling water distribution section 543 as the cooling water.

By reusing the condensed water of the condensed water circulation section 52 in this way, the cooling tower 5 does not need to introduce the cooling water from outside the system, and the operating cost of the cooling tower 5 can be reduced. Additionally, since the condensed water that has been cooled by the heat exchanger 523 of the condensed water circulation section 52 is used as the cooling water, the temperature of the exhaust gas G1 can be effectively lowered.

In addition, the cooling tower 5 further includes the cooling tower control unit 56 that causes the cooling section 54 to supply the cooling water in the case where the temperature of the exhaust gas G1 is equal to or higher than the limit temperature, and causes the cooling section 54 to stop supplying the cooling water in the case where the temperature of the exhaust gas G1 is lower than the limit temperature.

The cooling tower 5 can lower the temperature of the exhaust gas G1 with the cooling water in the case where the temperature of the exhaust gas G1 is equal to or higher than the limit temperature, and can stop supplying the cooling water in the case where the temperature of the exhaust gas G1 is lower than the limit temperature, thereby reducing the pump power required for the supply.

Moreover, the cooling tower control unit 56 stops the operation of the plant 1 in the case where the temperature of the exhaust gas G1 is equal to or higher than the upper limit temperature higher than the limit temperature.

The cooling tower 5 can prevent the deformation or damage to the cooling tower packing 51 due to the high-temperature exhaust gas G1 exceeding the upper limit temperature even in the case where it is difficult to lower the temperature of the exhaust gas G1 only by using the cooling water.

### Second Embodiment

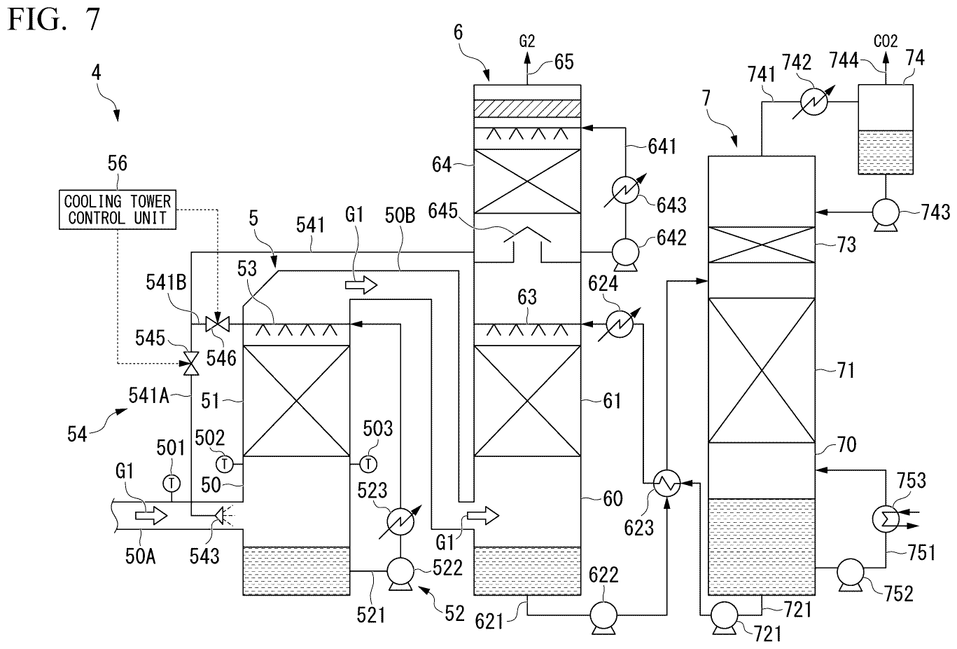

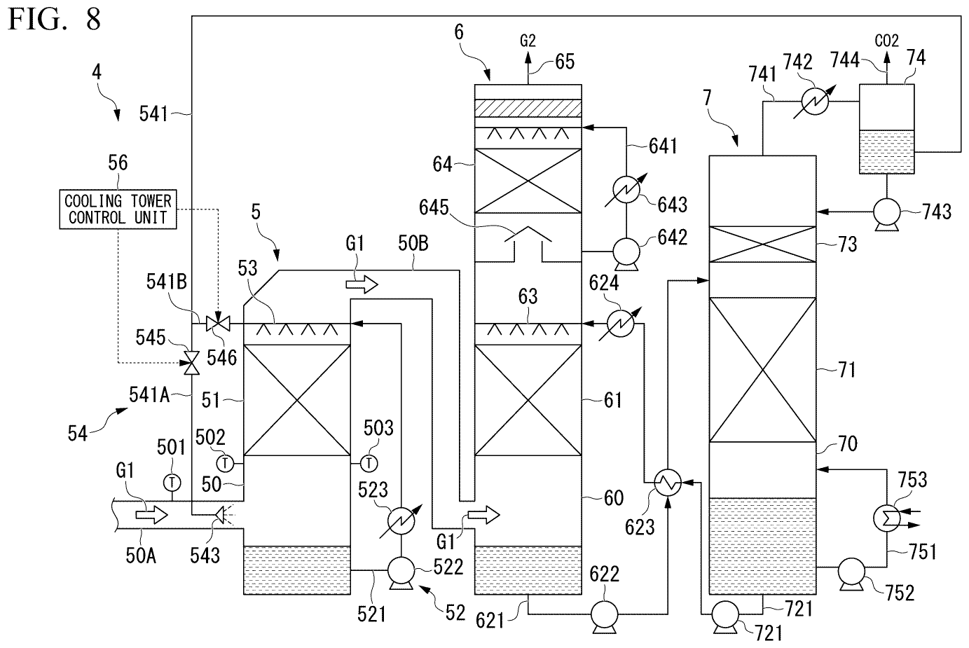

Next, a second embodiment will be described in detail with reference to FIGS. 7 and 8. The same components as those in the first embodiment are designated by the same reference numerals, and the detailed descriptions thereof will be omitted.

### (Configuration Example of Absorption Tower and Regeneration Tower)

FIG. 7 is a first schematic diagram showing a configuration example of a carbon dioxide capture device according to a second embodiment of the present disclosure. First, a configuration example of the absorption tower 6 will be described. As shown in FIG. 7, the absorption tower 6 includes a main body section 60, an absorption tower packing 61, an absorbing liquid distribution section 63, an absorption tower washing section 64, and a purified gas discharge flow passage 65.

The main body section 60 is a hollow container that extends in the vertical direction, and the exhaust gas G1 cooled by the cooling tower 5 flows in the vertical direction inside the main body section 60. The absorption tower packing 61 is a packing provided inside the main body section 60. The absorbing liquid distribution section 63 supplies the absorbing liquid (lean absorbing liquid) regenerated by the regeneration tower 7 to the absorption tower packing 61. In the absorption tower packing 61, the exhaust gas G1 and the absorbing liquid come into gas-liquid contact with each other, and carbon dioxide contained in the exhaust gas G1 is absorbed by the absorbing liquid and removed. The absorption tower washing section 64 washes the exhaust gas from which the carbon dioxide has been removed with washing water and discharges the washed exhaust gas as the purified gas G2 from the purified gas discharge flow passage 65 at the top of the absorption tower 6.

The washing water used in the absorption tower washing section 64 is stored in a chimney tray 645 provided between the absorption tower packing 61 and the absorption tower washing section 64. The washing water stored in the chimney tray 645 is pumped up by a pump 642 and is supplied from above the absorption tower washing section 64 through a washing water circulation flow passage 641. In addition, a heat exchanger 643 is provided in the washing water circulation flow passage 641 and cools the washing water to be supplied to the absorption tower washing section 64.

The absorbing liquid (rich absorbing liquid) that has absorbed the carbon dioxide in the absorption tower packing 61 is stored in a lower part of the main body section 60 of the absorption tower 6. The rich absorbing liquid is sent to the regeneration tower 7 through a rich absorbing liquid line 621 by a pump 622. The rich absorbing liquid is regenerated by the regeneration tower 7 to become the lean absorbing liquid and is sent to the regeneration tower 7 through a lean absorbing liquid line 721 by a pump 722. The rich absorbing liquid and the lean absorbing liquid are heat-exchanged by a heat exchanger 623. Additionally, a heat exchanger 624 that cools the lean absorbing liquid to a predetermined temperature is provided on a downstream side of the heat exchanger 623 (absorption tower 6 side) in a lean liquid flow direction of the lean absorbing liquid line 721.

Next, a configuration example of the regeneration tower 7 will be described. As shown in FIG. 7, the regeneration tower 7 includes a main body section 70, a regeneration tower packing 71, a regeneration tower washing section 73, and a reflux drum 74.

The main body section 70 is a tubular container that extends in the vertical direction. The regeneration tower packing 71 is provided inside the main body section 70. The absorbing liquid (rich absorbing liquid) that has absorbed the carbon dioxide in the absorption tower 6 is introduced above the regeneration tower packing 71 through the rich absorbing liquid line 621. While the absorbing liquid flows downward through the regeneration tower packing 71, the carbon dioxide is released from the rich absorbing liquid by steam. The carbon dioxide gas separated from the rich absorbing liquid flows upward in the main body section 70. The absorbing liquid (lean absorbing liquid) from which the carbon dioxide has been removed is stored below the main body section 70. The lean absorbing liquid is pumped up by a pump 752, flows through a lean absorbing liquid circulation flow passage 751, is heated by a reboiler 753 provided in the lean absorbing liquid circulation flow passage 751, and is returned to the main body section 70.

The regeneration tower washing section 73 supplies washing water to remove the absorbing liquid contained in the carbon dioxide gas. The carbon dioxide gas from which the absorbing liquid has been removed flows through a first discharge flow passage 741 from the top of the regeneration tower 7, and moisture contained in the carbon dioxide gas is condensed by a condenser 742 and introduced into the reflux drum 74. The reflux drum 74 separates the condensed water generated from the carbon dioxide gas and the carbon dioxide gas. The condensed water is stored in a lower part of the reflux drum 74 and is sent to the regeneration tower washing section 73 as the washing water by a pump 743. The carbon dioxide gas separated by the reflux drum 74 is discharged from the top of the reflux drum 74 to a capture tank or the like outside the system through a second discharge flow passage 744.

### (Configuration Example 1 of Cooling Tower)

In addition, the cooling tower 5 of the present embodiment differs from that of the first embodiment in the configuration of the cooling section 54. In Configuration Example 1 of the present embodiment, the cooling section 54 introduces the cooling water into the cooling water distribution section 543 from the cooling water supply source located at a position higher than that of the cooling water distribution section 543. The cooling water supply source is, for example, the chimney tray 645 of the absorption tower 6. One end of the cooling water flow passage 541 of the cooling section 54 is connected to the chimney tray 645 of the absorption tower 6. The other end of the cooling water flow passage 541 is connected to the cooling water distribution section 543 through an on-off valve 545. The cooling water supply source is not limited to being located inside the carbon dioxide capture system 100 and may be located outside.

Additionally, as in the example of FIG. 7, the cooling water flow passage 541 may branch into a first cooling water flow passage 541A connected to the cooling water distribution section 543 and a second cooling water flow passage 541B connected to the condensed water distribution section 53. The first cooling water flow passage 541A and the second cooling water flow passage 541B are provided with on-off valves 545 and 546. The on-off valves 545 and 546 open and close under the control of the cooling tower control unit 56. The cooling tower control unit 56 opens the on-off valves 545 and 546 to supply the cooling water to the cooling section 54 in the case where the temperature of the exhaust gas G1 exceeds the limit temperature, in the same manner as in the first embodiment. The on-off valves 545 and 546 may be manually opened and closed from outside the cooling tower 5.

### (Action and Effect of Configuration Example 1)

Since the washing water of the absorption tower 6 can be reused, the cooling tower 5 does not need to introduce the cooling water from outside the system, and the operating cost of the cooling tower 5 can be reduced. In addition, the chimney tray 645 of the absorption tower 6 is provided at a position higher than that of the cooling water distribution section 543 of the cooling section 54 and the condensed water distribution section 53. Therefore, simply by opening the on-off valves 545 and 546 provided in the cooling water flow passage 541, the washing water stored in the chimney tray 645 drops and is supplied as the cooling water to the cooling water distribution section 543 and the condensed water distribution section 53. Consequently, since a pump for sending the cooling water is not required, for example, even in the event of a power loss such as a power outage, the temperature of the exhaust gas G1 can be lowered by supplying the cooling water to the cooling water distribution section 543 in the case where the on-off valves 545 and 546 are open. In the case where a power loss occurs in a state in which the on-off valves 545 and 546 are closed, a worker may manually open the on-off valves 545 and 546. As a result, the deformation or damage to the cooling tower packing 51 can be prevented even in the event of a power loss.

Other configurations of the cooling section 54 are the same as those in the first embodiment. The configurations of the cooling water distribution section 543 and the second cooling tower packing 544 of the cooling section 54 may be any of the configurations shown in FIGS. 2 to 5.

### (Configuration Example 2 of Cooling Tower)

FIG. 8 is a second schematic diagram showing a configuration example of the carbon dioxide capture device according to the second embodiment of the present disclosure. In Configuration Example 2 of the present embodiment, the cooling section 54 introduces the cooling water into the cooling water distribution section 543 from a cooling water supply source having an internal pressure higher than that of the cooling tower 5. The cooling water supply source is, for example, the reflux drum 74 of the regeneration tower 7. As in the example of FIG. 8, one end of the cooling water flow passage 541 of the cooling section 54 is connected to the reflux drum 74 of the regeneration tower 7. The other end of the cooling water flow passage 541 is connected to the cooling water distribution section 543 through the on-off valve 545. The cooling water supply source is not limited to being located inside the carbon dioxide capture system 100 and may be located outside.

In addition, in the same manner as in Configuration Example 1, the cooling water flow passage 541 may branch into the first cooling water flow passage 541A connected to the cooling water distribution section 543 and the second cooling water flow passage 541B connected to the condensed water distribution section 53. The cooling tower control unit 56 opens the on-off valve 545 to supply the cooling water to the cooling section 54 in the case where the temperature of the exhaust gas G1 exceeds the limit temperature, in the same manner as in the first embodiment. The on-off valves 545 and 546 may be manually opened and closed from outside the cooling tower 5.

### (Action and Effect of Configuration Example 2)

Since reflux water of the reflux drum 74 of the regeneration tower 7 can be reused, the cooling tower 5 does not need to introduce the cooling water from outside the system, and the operating cost of the cooling tower 5 can be reduced. Additionally, during the operation of the carbon dioxide capture device 4, the reflux drum 74 of the regeneration tower 7 is in a state in which the internal pressure is higher than that of the cooling tower 5. Therefore, simply by opening the on-off valves 545 and 546 provided in the cooling water flow passage 541, the condensed water stored in the reflux drum 74 is sent and supplied as the cooling water to the cooling water distribution section 543 and the condensed water distribution section 53. Consequently, since a pump for sending the cooling water is not required, for example, even in the event of a power loss such as a power outage, the temperature of the exhaust gas G1 can be lowered by supplying the cooling water to the cooling water distribution section 543 in the case where the on-off valves 545 and 546 are open. In the case where a power loss occurs in a state in which the on-off valves 545 and 546 are closed, the worker may manually open the on-off valves 545 and 546. As a result, the deformation or damage to the cooling tower packing 51 can be prevented even in the event of a power loss.

Other configurations of the cooling section 54 are the same as those in the first embodiment. The configurations of the cooling water distribution section 543 and the second cooling tower packing 544 of the cooling section 54 may be any of the configurations shown in FIGS. 2 to 5.

### Computer Configuration

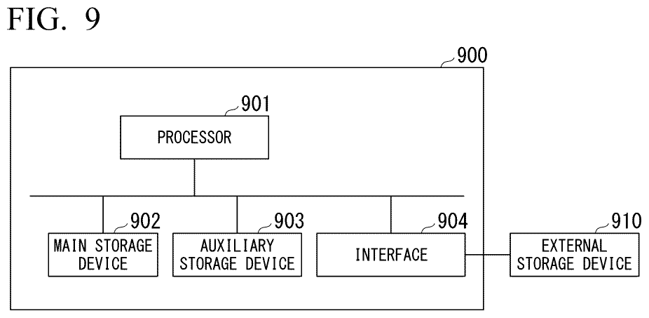

FIG. 9 is a schematic block diagram showing a configuration of a computer of the control unit according to at least one embodiment. A computer 900 includes a processor 901, a main storage device 902, an auxiliary storage device 903, and an interface 904.

The cooling tower control unit 56 of the cooling tower 5 mentioned above is implemented in the computer 900. The operation of the cooling tower control unit 56 mentioned above is stored in the auxiliary storage device 903 in a form of a program. The processor 901 reads the program from the auxiliary storage device 903, expands the program into the main storage device 902, and executes the above-described processing in accordance with the program. In addition, the processor 901 secures a storage area corresponding to each storage unit mentioned above in the main storage device 902 in accordance with the program.

The program may be used to implement some of the functions of the computer 900. For example, the program may exhibit the functions through a combination with other programs already stored in the auxiliary storage device 903 or a combination with other programs implemented in other devices. In another embodiment, the computer 900 may include a custom large-scale integrated circuit (LSI) such as a programmable logic device (PLD), in addition to the above-described configuration or instead of the above-described configuration. A programmable array logic (PAL), a generic array logic (GAL), a complex programmable logic device (CPLD), a field-programmable gate array (FPGA), and the like are exemplary examples of the PLD. In such a case, some or all of the functions implemented by the processor 901 may be implemented by the integrated circuit.

A hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like are exemplary examples of the auxiliary storage device 903. The auxiliary storage device 903 may be an internal medium connected directly to a bus of the computer 900 or an external storage device 910 connected to the computer 900 via the interface 904 or a communication line. Additionally, in the case where this program is distributed to the computer 900 via the communication line, the computer 900 that has received the distribution may expand the program into the main storage device 902 and execute the above-described processing. In at least one embodiment, the auxiliary storage device 903 is a non-transitory tangible storage medium.

As described above, several embodiments related to the present disclosure have been described above; however, all of these embodiments are presented as examples and are not intended to limit the scope of the invention. These embodiments can be implemented in various other forms, and various omissions, replacements, and changes can be made within the scope that does not depart from the gist of the invention. These embodiments and modifications thereof are included within the scope of the invention described in the claims and the equivalent scope thereof, as well as within the scope and the gist of the invention.

### Appendix

The cooling tower, the carbon dioxide capture device, and the method for protecting a cooling tower packing described in the above-mentioned embodiments are as understood, for example, as follows.
(1) According to a first aspect, the cooling tower 5 that cools the exhaust gas G1 includes: the resin-made cooling tower packing 51 that cools the exhaust gas G1 flowing from the lower part to the upper part inside the cooling tower 5 in the vertical direction, the condensed water circulation section 52 including the condensed water circulation flow passage 521 through which the condensed water stored in the lower part of the cooling tower 5 is pumped up by the pump 522 and circulated to the upper part of the cooling tower 5, and the heat exchanger 523 that cools the condensed water flowing through the condensed water circulation flow passage 521, the condensed water distribution section 53 connected to the condensed water circulation flow passage 521 at the upper part of the cooling tower 5 and that supplies the condensed water from above the cooling tower packing 51 to the cooling tower packing 51, and the cooling section 54 including the cooling water distribution section 543 that supplies the cooling water for cooling the exhaust gas G1 to the upstream side of the cooling tower packing 51 in the flow direction of the exhaust gas G1.

The cooling tower 5 can prevent the high-temperature exhaust gas G1 exceeding the heat resistance temperature from flowing into the resin-made cooling tower packing 51. As a result, the risk of deformation or damage to the cooling tower packing 51 can be reduced, thereby extending the lifespan of the cooling tower packing 51.
(2) According to a second aspect, in the cooling tower 5 according to the first aspect, the cooling water distribution section 543 of the cooling section 54 supplies the cooling water to the inside of the exhaust gas introduction flow passage 50A through which the exhaust gas G1 is introduced into the cooling tower 5.

The cooling tower 5 can lower the temperature of the exhaust gas G1 before the exhaust gas G1 flows into the cooling tower 5. Therefore, it is possible to prevent the high-temperature exhaust gas G1 exceeding the heat resistance temperature from flowing into the resin-made cooling tower packing 51.
(3) According to a third aspect, in the cooling tower 5 according to the first aspect, the cooling water distribution section 543 of the cooling section 54 supplies the cooling water to the cooling tower packing 51 from below the cooling tower packing 51.

The cooling tower 5 can cool the lower side of the cooling tower packing 51 with the cooling water together with the exhaust gas G1, thereby preventing the exhaust gas G1 and the cooling tower packing 51 from being high temperature exceeding the heat resistance temperature of the cooling tower packing 51.
(4) According to a fourth aspect, in the cooling tower 5 according to any one of the first to third aspects, the cooling section 54 further includes the second cooling tower packing 544 disposed below the cooling tower packing 51 and that has a heat resistance temperature higher than the heat resistance temperature of the cooling tower packing 51.

The cooling tower 5 can lower the temperature of the exhaust gas G1 with the second cooling tower packing 544 having a higher heat resistance temperature before the exhaust gas G1 flows through the cooling tower packing 51. Therefore, it is possible to prevent the high-temperature exhaust gas G1 exceeding the heat resistance temperature from flowing into the resin-made cooling tower packing 51.
(5) According to a fifth aspect, in the cooling tower 5 according to the first aspect, the cooling section 54 further includes the second cooling tower packing 544 disposed below the cooling tower packing 51 and that has a heat resistance temperature higher than the heat resistance temperature of the cooling tower packing 51, and the cooling water distribution section 543 is provided between the cooling tower packing 51 and the second cooling tower packing 544 and supplies the cooling water to the second cooling tower packing 544.

The cooling tower 5 can more reliably lower the temperature of the exhaust gas G1 before the exhaust gas G1 reaches the cooling tower packing 51 by using the second cooling tower packing 544 and the cooling water.
(6) According to a sixth aspect, in the cooling tower 5 according to any one of the first to fifth aspects, the cooling section 54 includes the cooling water flow passage 541 that branches from the condensed water circulation flow passage 521 at the downstream side of the heat exchanger 523 and through which some of the condensed water cooled by the heat exchanger 523 is introduced into the cooling water distribution section 543 as the cooling water.

By reusing the condensed water of the condensed water circulation section 52 in this way, the cooling tower 5 does not need to introduce the cooling water from outside the system, and the operating cost of the cooling tower 5 can be reduced. Additionally, since the condensed water that has been cooled by the heat exchanger 523 of the condensed water circulation section 52 is used as the cooling water, the temperature of the exhaust gas G1 can be effectively lowered.
(7) According to a seventh aspect, in the cooling tower 5 according to any one of the first to fifth aspects, the cooling section 54 introduces the cooling water into the cooling water distribution section 543 from the cooling water supply source provided at a position higher than the position of the cooling water distribution section 543.

The cooling tower 5 can supply the cooling water dropping from the cooling water supply source located at a higher position to the cooling water distribution section 543 and the condensed water distribution section 53 simply by opening the on-off valves 545 and 546 provided in the cooling water flow passage 541. Consequently, since a pump for sending the cooling water is not required, for example, even in the event of a power loss such as a power outage, the temperature of the exhaust gas G1 can be lowered by supplying the cooling water to the cooling water distribution section 543. As a result, the deformation or damage to the cooling tower packing 51 can be prevented even in the event of a power loss.
(8) According to an eighth aspect, in the cooling tower 5 according to the seventh aspect, the cooling water supply source is the chimney tray 645 provided at a position higher than the position of the cooling water distribution section 543 in the absorption tower 6 provided downstream of the cooling tower 5, and the cooling section 54 includes the cooling water flow passage 541 through which the washing water stored in the chimney tray 645 is introduced into the cooling water distribution section 543 as the cooling water.

Since the washing water of the absorption tower 6 can be reused, the cooling tower 5 does not need to introduce the cooling water from outside the system, and the operating cost of the cooling tower 5 can be reduced. In addition, the chimney tray 645 of the absorption tower 6 is provided at a position higher than that of the cooling water distribution section 543 of the cooling section 54 and the condensed water distribution section 53. Therefore, simply by opening the on-off valves 545 and 546 provided in the cooling water flow passage 541, the washing water stored in the chimney tray 645 drops and is supplied as the cooling water to the cooling water distribution section 543 and the condensed water distribution section 53. Consequently, since a pump for sending the cooling water is not required, for example, even in the event of a power loss such as a power outage, the temperature of the exhaust gas G1 can be lowered by supplying the cooling water to the cooling water distribution section 543. As a result, the deformation or damage to the cooling tower packing 51 can be prevented even in the event of a power loss.
(9) According to a ninth aspect, in the cooling tower 5 according to any one of the first to fifth aspects, the cooling section 54 introduces the cooling water into the cooling water distribution section 543 from the cooling water supply source having an internal pressure higher than the internal pressure of the cooling tower 5.

The cooling tower 5 can supply the cooling water sent from the cooling water supply source using a pressure difference to the cooling water distribution section 543 and the condensed water distribution section 53 simply by opening the on-off valves 545 and 546 provided in the cooling water flow passage 541. Consequently, since a pump for sending the cooling water is not required, for example, even in the event of a power loss such as a power outage, the temperature of the exhaust gas G1 can be lowered by supplying the cooling water to the cooling water distribution section 543. As a result, the deformation or damage to the cooling tower packing 51 can be prevented even in the event of a power loss.
(10) According to a tenth aspect, in the cooling tower 5 according to the ninth aspect, the cooling water supply source is the reflux drum 74 of the regeneration tower 7 provided downstream of the cooling tower 5, the reflux drum 74 having an internal pressure higher than the internal pressure of the cooling tower 5, and the cooling section 54 includes the cooling water flow passage 541 through which reflux water stored in the reflux drum 74 is introduced into the cooling water distribution section 543 as the cooling water, the cooling water flow passage 541 being connected to the reflux drum 74.

Since the reflux water of the reflux drum 74 of the regeneration tower 7 can be reused, the cooling tower 5 does not need to introduce the cooling water from outside the system, and the operating cost of the cooling tower 5 can be reduced. Additionally, during the operation of the carbon dioxide capture device 4, the reflux drum 74 of the regeneration tower 7 is in a state in which the internal pressure is higher than that of the cooling tower 5. Therefore, simply by opening the on-off valves 545 and 546 provided in the cooling water flow passage 541, the condensed water stored in the reflux drum 74 is sent and supplied as the cooling water to the cooling water distribution section 543 and the condensed water distribution section 53. Consequently, since a pump for sending the cooling water is not required, for example, even in the event of a power loss such as a power outage, the temperature of the exhaust gas G1 can be lowered by supplying the cooling water to the cooling water distribution section 543. As a result, the deformation or damage to the cooling tower packing 51 can be prevented even in the event of a power loss.
(11) According to an eleventh aspect, in the cooling tower 5 according to any one of the first to tenth aspects, at least one of the first temperature sensor 501 that measures the temperature of the exhaust gas G1 at the outlet of the exhaust gas introduction flow passage 50A through which the exhaust gas G1 is introduced into the cooling tower 5 and the second temperature sensors 502 and 503 that measure the temperature of the exhaust gas G1 below the cooling tower packing 51, and the cooling tower control unit 56 that causes the cooling section 54 to supply the cooling water in the case where the temperature of the exhaust gas G1 is equal to or higher than the limit temperature corresponding to the heat resistance temperature of the cooling tower packing 51 and that causes the cooling section 54 to stop supplying the cooling water in the case where the temperature of the exhaust gas G1 is lower than the limit temperature are further provided.

The cooling tower 5 can lower the temperature of the exhaust gas G1 with the cooling water in the case where the temperature of the exhaust gas G1 is equal to or higher than the limit temperature, and can stop supplying the cooling water in the case where the temperature of the exhaust gas G1 is lower than the limit temperature, thereby preventing excessive consumption of the cooling water and excessive decrease in the temperature of the exhaust gas G1.
(12) According to a twelfth aspect, in the cooling tower 5 according to the ninth aspect, the cooling tower 5 is provided in the plant 1 that discharges the exhaust gas G1, and the cooling tower control unit 56 stops the operation of the plant 1 in the case where the temperature of the exhaust gas G1 is equal to or higher than the upper limit temperature higher than the limit temperature.

The cooling tower 5 can prevent the deformation or damage to the cooling tower packing 51 due to the high-temperature exhaust gas G1 exceeding the limit temperature even in the case where it is difficult to lower the temperature of the exhaust gas G1 only by using the cooling water.
(13) According to a thirteenth aspect, in the cooling tower 5 according to the eleventh or twelfth aspect, the second temperature sensors 502 and 503 are provided below the cooling tower packing 51 at at least two different positions in the horizontal direction.

The cooling tower 5 can prevent the detection of the temperature rise of the exhaust gas G1 from being omitted even in the case where the temperature of the exhaust gas G1 varies depending on the position in the horizontal direction (temperature variations occur).
(14) According to a fourteenth aspect, the carbon dioxide capture device 4 includes: the cooling tower 5 according to any one of the first to thirteenth aspects; the absorption tower 6 that removes carbon dioxide contained in the exhaust gas G1 cooled by the cooling tower 5 by absorbing the carbon dioxide into the absorbing liquid; and the regeneration tower 7 that regenerates the absorbing liquid by separating the carbon dioxide from the absorbing liquid discharged from the absorption tower 6.

The carbon dioxide capture device 4 can prevent the high-temperature exhaust gas G1 exceeding the heat resistance temperature from flowing into the resin-made cooling tower packing 51 of the cooling tower 5. As a result, the risk of deformation or damage to the cooling tower packing 51 can be reduced, thereby extending the lifespan of the cooling tower packing 51.
(15) According to a fifteenth aspect, the method for protecting the resin-made cooling tower packing 51 that cools the exhaust gas G1 flowing inside the cooling tower 5 includes: a step of circulating the condensed water stored in the lower part of the cooling tower 5 to the upper part of the cooling tower 5 through the condensed water circulation flow passage 521 by pumping up the condensed water with the pump 522 and of cooling the condensed water flowing through the condensed water circulation flow passage 521 with the heat exchanger 523; a step of supplying the condensed water from above the cooling tower packing 51 to the cooling tower packing 51 by the condensed water distribution section 53 connected to the condensed water circulation flow passage 521 at the upper part of the cooling tower 5; and a step of supplying cooling water for cooling the exhaust gas G1 to the upstream side of the cooling tower packing 51 in the flow direction of the exhaust gas G1 by the cooling water distribution section 543.

### EXPLANATION OF REFERENCES

1: plant
100: carbon dioxide capture system
2: dust collection device
3: desulfurization device
4: carbon dioxide capture device
5: cooling tower
50: main body section
50A: exhaust gas introduction flow passage
50B: exhaust gas discharge flow passage
51: cooling tower packing
52: condensed water circulation section
521: condensed water circulation flow passage
522: pump
523: heat exchanger
53: condensed water distribution section
54: cooling section
541: cooling water flow passage
542: cooling water control valve
543: cooling water distribution section
544: second cooling tower packing
545: on-off valve
546: on-off valve
56: cooling tower control unit
6: absorption tower
60: main body section
61: absorption tower packing
61A: first absorption tower packing
61B: second absorption tower packing
63: absorbing liquid distribution section
63A: first absorbing liquid distribution section
63B: second absorbing liquid distribution section
621: rich absorbing liquid line
622: pump
623: heat exchanger
624: heat exchanger
625: absorbing liquid control valve
64: absorption tower washing section
641: washing water circulation flow passage
642: pump
643: heat exchanger
645: chimney tray
65: purified gas discharge flow passage
7: regeneration tower
74: reflux drum
721: lean absorbing liquid line

1. A cooling tower that cools exhaust gas, comprising:
a resin-made cooling tower packing configured to cool the exhaust gas flowing from a lower part to an upper part inside the cooling tower in a vertical direction;
a condensed water circulation section including a condensed water circulation flow passage through which condensed water stored in the lower part of the cooling tower is pumped up by a pump and circulated to the upper part of the cooling tower, and a heat exchanger configured to cool the condensed water flowing through the condensed water circulation flow passage;
a condensed water distribution section connected to the condensed water circulation flow passage at the upper part of the cooling tower and configured to supply the condensed water from above the cooling tower packing to the cooling tower packing; and
a cooling section including a cooling water distribution section configured to supply cooling water for cooling the exhaust gas to an upstream side of the cooling tower packing in a flow direction of the exhaust gas.

2. The cooling tower according to claim 1, wherein the cooling water distribution section of the cooling section supplies the cooling water to an inside of an exhaust gas introduction flow passage through which the exhaust gas is introduced into the cooling tower.

3. The cooling tower according to claim 1, wherein the cooling water distribution section of the cooling section supplies the cooling water to the cooling tower packing from below the cooling tower packing.

4. The cooling tower according to claim 1, wherein the cooling section further includes a second cooling tower packing disposed below the cooling tower packing and that has a heat resistance temperature higher than a heat resistance temperature of the cooling tower packing.

5. The cooling tower according to claim 1, wherein
the cooling section further includes a second cooling tower packing disposed below the cooling tower packing and that has a heat resistance temperature higher than a heat resistance temperature of the cooling tower packing, and
the cooling water distribution section is provided between the cooling tower packing and the second cooling tower packing and supplies the cooling water to the second cooling tower packing.

6. The cooling tower according to claim 1, wherein the cooling section includes a cooling water flow passage through which some of the condensed water cooled by the heat exchanger is introduced into the cooling water distribution section as the cooling water, the cooling water flow passage branching from the condensed water circulation flow passage at a downstream side of the heat exchanger.

7. The cooling tower according to claim 1, wherein the cooling section introduces the cooling water into the cooling water distribution section from a cooling water supply source provided at a position higher than a position of the cooling water distribution section.

8. The cooling tower according to claim 7, wherein
the cooling water supply source is a chimney tray provided at a position higher than the position of the cooling water distribution section in an absorption tower provided downstream of the cooling tower, and
the cooling section includes a cooling water flow passage through which washing water stored in the chimney tray is introduced into the cooling water distribution section as the cooling water.

9. The cooling tower according to claim 1, wherein the cooling section introduces the cooling water into the cooling water distribution section from a cooling water supply source having an internal pressure higher than an internal pressure of the cooling tower.

10. The cooling tower according to claim 9, wherein
the cooling water supply source is a reflux drum of a regeneration tower provided downstream of the cooling tower, the reflux drum, the reflux drum having an internal pressure higher than the internal pressure of the cooling tower, and
the cooling section includes a cooling water flow passage through which reflux water stored in the reflux drum is introduced into the cooling water distribution section as the cooling water, the cooling water flow passage being connected to the reflux drum.

11. The cooling tower according to claim 1, further comprising:
at least one of a first temperature sensor configured to measure a temperature of the exhaust gas at an outlet of an exhaust gas introduction flow passage through which the exhaust gas is introduced into the cooling tower and a second temperature sensor configured to measure the temperature of the exhaust gas below the cooling tower packing; and
a cooling tower control unit configured to cause the cooling section to supply the cooling water in a case where the temperature of the exhaust gas is equal to or higher than a limit temperature corresponding to a heat resistance temperature of the cooling tower packing and configured to cause the cooling section to stop supplying the cooling water in a case where the temperature of the exhaust gas is lower than the limit temperature.

12. The cooling tower according to claim 11, wherein
the cooling tower is provided in a plant configured to discharge the exhaust gas, and
the cooling tower control unit stops an operation of the plant in the case where the temperature of the exhaust gas is equal to or higher than an upper limit temperature higher than the limit temperature.

13. The cooling tower according to claim 11, wherein the second temperature sensor is provided below the cooling tower packing at at least two different positions in a horizontal direction.

14. A carbon dioxide capture device, comprising:
the cooling tower according to claim 1;
an absorption tower configured to remove carbon dioxide contained in the exhaust gas cooled by the cooling tower by absorbing the carbon dioxide into an absorbing liquid; and
a regeneration tower configured to regenerate the absorbing liquid by separating the carbon dioxide from the absorbing liquid discharged from the absorption tower.

15. A method for protecting a resin-made cooling tower packing that cools exhaust gas flowing inside a cooling tower, the method comprising:
a step of circulating condensed water stored in a lower part of the cooling tower to an upper part of the cooling tower through a condensed water circulation flow passage by pumping up the condensed water with a pump and of cooling the condensed water flowing through the condensed water circulation flow passage with a heat exchanger;
a step of supplying the condensed water from above the cooling tower packing to the cooling tower packing by a condensed water distribution section connected to the condensed water circulation flow passage at the upper part of the cooling tower; and
a step of supplying cooling water for cooling the exhaust gas to an upstream side of the cooling tower packing in a flow direction of the exhaust gas by a cooling water distribution section.
